(19) United States
(12) Patent Application Publication
(10) Pub. No.: US 2025/0193950 A1
(43) Pub. Date: Jun. 12, 2025

(54) SYSTEM AND METHOD FOR TEMPORARY DEVICE PAIRING

(71) Applicant: Universal City Studios LLC, Universal City, CA (US)

(72) Inventor: Patrick John Goergen, Orlando, FL (US)

(21) Appl. No.: 18/975,981

(22) Filed: Dec. 10, 2024

Related U.S. Application Data
(60) Provisional application No. 63/608,641, filed on Dec. 11, 2023.

(51) Int. Cl. H04W 76/14; G06F 3/01; H04L 41/0806; H04L 67/306

(52) U.S. Cl. CPC H04W 76/14; H04L 41/0806; H04L 67/306; G06F 3/011

(57) ABSTRACT

A temporary device pairing system may use guest data captured by a guest information device to pair an individual guest with an individual attraction device. The guest information device may include a sensor that captures guest data, a processor configured to determine guest information from the acquired data; and communication circuitry configured to wirelessly communicate the guest information to an attraction device to pair the attraction device to the guest.

### CROSS-REFERENCE TO RELATED APPLICATIONS

This application claims priority from and the benefit of U.S. Provisional Application Ser. No. 63/608,641, entitled “SYSTEM AND METHOD FOR TEMPORARY DEVICE PAIRING”, filed Dec. 11, 2023, which is hereby incorporated by reference in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

An amusement park may include various entertainment attractions that are useful in entertaining guests. Certain attractions may include devices that are temporarily associated with a particular guest. In one example, a guest may be provided with a head-mounted display that is worn by the guest during a cycle of the attraction. After the attraction cycle is completed, the head-mounted display is returned and subsequently provided to additional guests. Thus, a device may be associated with a particular attraction rather than being associated with an individual guest.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a temporary device pairing system includes a guest information device. The guest information device includes a sensor configured to acquire guest data, a processing system configured to determine guest information from the acquired data, and communication circuitry configured to wirelessly communicate the guest information. The temporary device pairing system also includes a head-mounted display that includes head-mounted display communication circuitry configured to receive the guest information from the guest information device; and a display configured to adjust display of images based on the received guest information.

In an embodiment, a temporary device pairing method includes steps of receiving, at a guest information device, a request to temporarily pair a head-mounted display with a guest; activating a camera of the guest information device based on the request; acquiring, using the camera, an image of the guest; identifying one or more guest biometrics in the image; and communicating guest information indicative of the one or more guest biometrics to the head-mounted display to cause the head-mounted display to adjust an operation of the head-mounted display based on the guest information.

In an embodiment, a temporary device pairing system includes an attraction controller configured to control cycles of an amusement park attraction. The temporary device pairing system also includes a guest information device that includes a sensor configured to acquire guest data; a processing system configured to determine guest information from the acquired data; and communication circuitry configured to wirelessly communicate the guest information. The temporary device pairing system also includes an attraction device in communication with the attraction controller that includes device communication circuitry configured to receive the guest information from the guest information device; and a device controller configured operate based on instructions from the attraction controller and to adjust operation of the attraction device during an individual cycle of the amusement park attraction based on the guest information.

### DRAWINGS

These and other features, aspects, and advantages of the present disclosure will become better understood when the following detailed description is read with reference to the accompanying drawings in which like characters represent like parts throughout the drawings, wherein:

FIG. 1 is a flow diagram of a process for temporary device pairing, according to embodiments of the present disclosure;

FIG. 2 is a schematic illustration of an amusement attraction that may be used in conjunction with a temporary device pairing system, in accordance with present techniques;

FIG. 3 is a flow diagram of a process for temporarily pairing an attraction with a guest using a guest information device, according to embodiments of the present disclosure;

FIG. 4 is a schematic illustration of temporary pairing of a head-mounted display with a guest using a guest mobile device, according to embodiments of the present disclosure;

FIG. 5 is a schematic illustration of temporary pairing of a head-mounted display with a guest using a kiosk, according to embodiments of the present disclosure;

FIG. 6 is a schematic view of a two-part head-mounted display that may be used in conjunction with a temporary device pairing system, according to embodiments of the present disclosure;

FIG. 7 is a depiction of a graphical user interface (GUI) of a head-mounted display that may be used in conjunction with a temporary device pairing system, according to embodiments of the present disclosure;

FIG. 8 is a depiction of a graphical user interface (GUI) of a guest information device that may be used in conjunction with a temporary device pairing system, according to embodiments of the present disclosure; and

FIG. 9 is a block diagram of the temporary device pairing system, in accordance with present embodiments.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

An amusement park attraction may be used in conjunction with accessory attraction devices that are distributed to guests for use during an attraction cycle but that are retained with the attraction to be used by successive groups of guests. For example, the attraction may distribute head-mounted displays, blasters, wands, or other handheld or wearable devices for use inside the attraction. Typically, such attraction devices may be distributed to guests before entering the attraction and are collected after the guests exit. Thus, an individual attraction device may be used by several different guests in a single day. Accordingly, providing customization and individual tuning in a high-turnover environment is challenging and time-consuming.

Provided herein is a temporary device pairing system that can be used to capture guest information for temporarily pairing an attraction device to the guest based on the guest information. The temporary pairing may involve tuning physical parameters of the attraction device and/or adjusting an operation of the attraction device based on the guest information. The guest information may be captured in an anonymous and temporary manner that, in embodiments, is not tied to an established guest profile or guest profile information. Thus, the guest may be paired with an attraction device without having to set up an account that stores the guest information. In this manner, the guest information may be anonymously acquired and only temporarily retained.

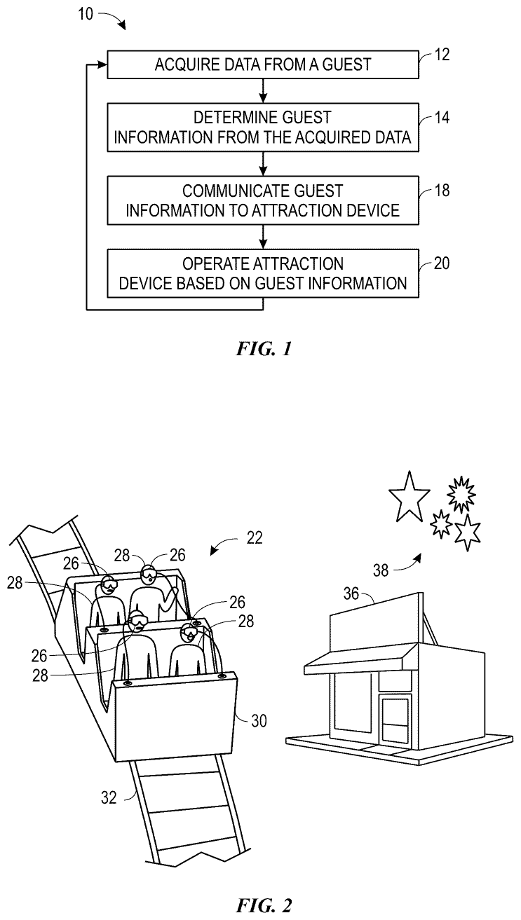

FIG. 1 is a flow diagram of a process 10 for temporary device pairing that may be used in conjunction with the disclosed embodiments. The process 10 may initiate with acquiring data from a guest (block 12), for example guest data. The guest may be a guest of an amusement park or other entertainment venue that distributes attraction devices for temporary pairing. The attraction devices, when paired, can be used during an attraction cycle and subsequently collected or returned by the guest at the conclusion of the attraction cycle. The amusement park attraction or entertainment venue may include a distribution process for attraction devices that is used in the temporary device pairing system (see FIG. 9). As discussed in additional detail herein, the data may be acquired from one or more sensors of the temporary device pairing system.

In an embodiment, the guest information may be data indicative of a guest characteristic or biometric. Guest characteristics or biometrics may include interpupillary distance, fingerprints, facial characteristics, height, limb length, voice patterns, gait, lip movement, hair color, eye color, clothing items or accessories (jewelry, hats, bags), tattoos, or other sensor-identifiable guest information. In an embodiment, the guest information may be related to estimated value of an interaction the attraction device or the attraction, such as a reflex speed and/or strength. Thus, the disclosed process may use data indicative of the guest characteristic or biometric, which may include guest characteristic data and/or guest biometric data.

The acquired data may be used to determine guest information (block 14). The determined guest information can be communicated to an individual attraction device (block 18), and one or more operations of the attraction device are adjusted, activated, deactivated, and/or modified based on the guest information (block 20). Thus, when an individual attraction device is paired to an individual guest, the operation of the attraction device may be affected by the guest information. However, the pairing is temporary, and acquiring data from another (e.g., a second) guest iterates the process back to determine guest information (block 14) using the updated acquired data. As new guest information is determined, the existing or old guest information may be rewritten or replaced. In an embodiment, each set of guest information is cleared from the attraction device automatically at the conclusion of an attraction cycle. Thus, the guest information may not be retained after the attraction device is no longer in use by the guest. In this manner, guests may have improved privacy, while attraction operators may have simplified and more efficient data handling.

In one example, the attraction device may be an augmented reality (AR), a virtual reality (VR), and/or a mixed reality (a combination of AR and VR) system (e.g., AR/VR system) used to enhance a guest experience of an amusement park attraction by providing guests with AR/VR experiences (e.g., AR experiences, VR experiences, or both). For example, the AR/VR system may include a head-mounted display (e.g., electronic goggles or displays, eyeglasses), which may be worn by a guest to enable the guest to view virtual or augmented reality features. In particular, the head-mounted display may be utilized to enhance a guest experience by overlaying virtual features onto a real-world environment of the amusement park, by providing adjustable virtual environments to provide different experiences in an attraction, and so forth.

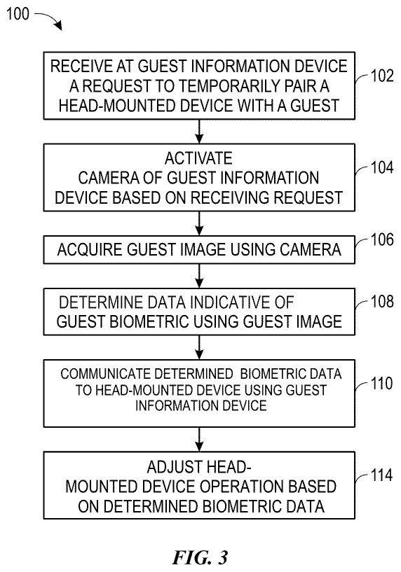

FIG. 2 is a representation of an amusement ride 22 that may be used in conjunction with the disclosed temporary device pairing system. The temporary device pairing system may be used to temporarily pair head-mounted displays 26 to respective guests 28. The amusement ride 22, as illustrated, includes a ride vehicle 30 that travels along a ride path 32. However, it should be understood that the disclosed embodiments for temporary device pairing may be implemented in attractions without ride vehicles 30, such as attractions such as shows or self-directed experiences in which the guests 28 traverse the attraction independently. As shown in FIG. 2 guests 28 are positioned or seated within the ride vehicle 30 and each guest 28 has an associated head-mounted display 26 that displays images and, in embodiments, may provide accompanying audio content to enhance the attraction experience. The head-mounted displays 26 may be configured for one or both of AR or VR content. In an AR implementation, at least at certain times of the ride, the guests 28 may be able to view physical structures in the real-world environment 36 through the screens of the head-mounted displays 26 as well as displayed virtual features 38. The head-mounted displays may, additionally or alternatively, be used in a fully immersive VR configuration in which the guests 28 view the displayed images on the head-mounted displays 26 in an immersive manner and cannot view the real-world environment through the lenses of the head-mounted display 26. However, it should be understood that the displayed images may include images of the physical structures that are captured by cameras and, in turn provided as displayed images on the head-mounted displays 26. Each guest 28 may be presented with different virtual features 38 so that each guest 28 has a different experience on the ride 22 in an embodiment.

Head-mounted displays 26 may be tuned based on individual guest anatomy to provide a secure fit as well as to adjust display settings to account for different eye-eye or interpupillary distances that may affect focus. The optical center of the head-mounted display should be positioned correctly relative to the center of the pupils for the displayed images to be accurate. Discrepancies between the head-mounted display lens spacing relative to the guest interpupillary distance can cause images to be displayed in a manner that does not seem realistic. In some cases, a head-mounted display 26 may have a knob that adjusts a distance between left and right lenses to change the optical center of the lenses, which tunes the lenses for better focus for an individual guest. However, in an amusement park attraction setting, such individual tuning can be time-consuming and can hold up ride loading, which in turn creates longer queues and a less satisfactory experience. Further, each group of guests 28 will have different familiarity with mechanical settings and the desired focus outcome. Certain head-mounted displays 26 may perform software-based corrections. However, these corrections use an estimated interpupillary distance as an input, and measurement of the interpupillary distance and entering the value into a user interface of the head-mounted display can also be complex for a large group of guests 28. For certain attractions, the head-mounted displays 26 may be tethered to the ride vehicle 30, and individual tuning at the ride vehicle 30 may hold up dispatching the ride vehicle 30, lengthening the time between ride cycles.

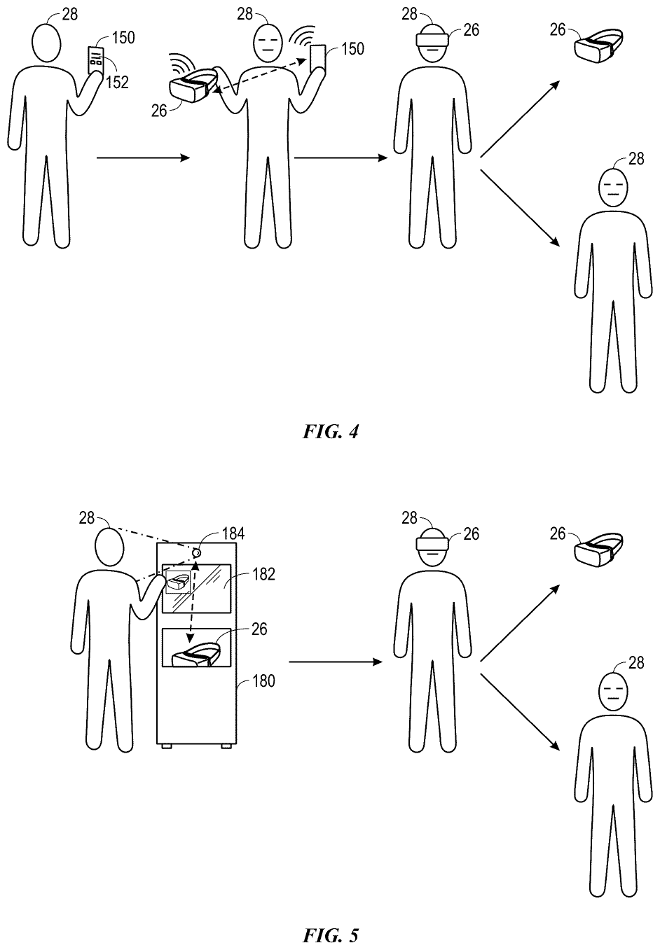

FIG. 3 is a flow diagram of a process 100 for temporary pairing of a head-mounted display 26 at an attraction or entertainment venue. The process may be used in conjunction with certain features of FIG. 1-2 as discussed above. The process 100 may provide temporary device pairing that may permit data indicative of guest information, (e.g., guest biometric, guest characteristic) determination using a camera of a guest information device. The process 100 initiates with receiving, at a guest information device, a request to temporarily pair a head-mounted display with a guest (block 102). The request may be received using the guest information device. In an embodiment, the guest information device may be a guest mobile device (see FIG. 4) or a kiosk (see FIG. 5) or tablet that may be operated by the guest. In an embodiment, the guest information device may be an operator tablet of an attraction operator. The guest information device may be located at an attraction loading area or in an attraction queue. For example, the guest information device, when implemented on the guest mobile device, may be used by the guest while in the attraction queue in advance of attraction loading.

Receipt of the request may trigger activation of a camera of the guest information device (block 104) to acquire an image of the guest (block 106). The guest image is used to identify or determine data indicative of one or more guest characteristics, such as one or more guest biometrics (block 108). For example, the one or more guest characteristics may include guest clothing (e.g., a blue t-shirt, hat), tattoos, hair color, eye color, etc. The one or more guest biometrics may include an interpupillary distance in an embodiment. In one example, the camera of the guest device acquires an image of the guest that includes the guest's face and both eyes. Using object recognition, the pupils of the eyes are identified, and a distance between the pupils is estimated. In an embodiment, the camera is a depth camera. The guest biometric data determination may be performed on the guest information device and communicated to the head-mounted display (block 110).

When the head-mounted display receives the guest biometric data, operation of the head-mounted display can be adjusted based on the guest biometric data (block 114). In an embodiment, the head-mounted display can adjust a previous or default setting based on the guest information. The process 100 permits pairing of an attraction device, such as the head-mounted display, to an individual guest without requiring the guest's name or personal identifying information. While characteristics of the guest may be captured as part of the process, this information may not be tied to the guest's identification information in an embodiment.

For example, when the guest biometric is an interpupillary distance, determined guest biometric data including the guest's interpupillary distance can be provided to a controller of the head-mounted display as biometric data. The controller can adjust the interpupillary distance setting from a default setting representative of an average interpupillary distance (e.g., 64 mm) to the received guest biometric data. The displayed images, such as AR/VR images can be adjusted to account for the difference between the guest interpupillary distance and the default setting. In one example, a software-based adjustment shifts the position of displayed pixels on a display of head-mounted display to the left and/or right to create appropriate spacing such that the optical center of the display aligns with the estimated guest interpupillary distance. In other embodiments, the head-mounted display can guide the guest through a manual adjustment (see FIG. 7). The process 100 permits the interpupillary distance measurement, or other guest biometric measurement, to be performed by a guest information device in advance of the guest entering the attraction or loading into the attraction. Further, the process 100 may be performed before the head-mounted display is distributed to the guest.

FIG. 4 is a schematic illustration of a device pairing of the temporary device pairing system of the present techniques used in conjunction with a guest mobile device 150. The guest mobile device 150 may execute instructions from a software application operating on the guest mobile device 150 to open an interface of the temporary device pairing system. For example, the guest may open the software application and/or press a button or click a link to initiate the device pairing. The device pairing may activate a camera of the mobile device 150, which may have an overlay or prompt displayed on a user interface 152. The overlay may guide the guest 28 to a correct position such that the camera can capture the appropriate features. The guest mobile device 150, having captured the image, can determine the guest information automatically. In embodiments, the guest mobile device 150 may display a confirmation screen indicating that the captured image is sufficient and/or that the guest information has been determined.

Once captured, the guest 28 can proceed to receive a head-mounted display 26. The head-mounted displays 26 may be distributed to guests 28 at a distribution location, which may be part of an attraction queue or dispatch area in an embodiment. The distribution may be self-directed, where each guest takes a head-mounted display 26 from a repository, such a container. The distribution may be operator-mediated, whereby an operator hands the head-mounted display 26 to the guest 28. In any case, the head-mounted display 26 may be generally randomly provided, such that any guest can receive any head-mounted display 26, which provides a more streamlined process. After receiving the head-mounted display 26, the guest can pair the head-mounted display 26 to the guest information by bringing the guest mobile device 150 into communication range of the head-mounted display 26 to initiate transmitting of the determined guest information to be received by communication circuitry of the head-mounted display 26. In an embodiment, the pairing is mediated by near-field communication such that the pairing range is 5 cm or less, and only a head-mounted display 26 that is in range of the mobile device 150 will be paired. In an embodiment, the pairing is mediated by Bluetooth communication, and the mobile device 150 may display a list of potential head-mounted displays 26, for example displaying different identification numbers. The guest can reference a visible indicator of the identification number on the head-mounted display 26 (such as a sticker or printed indicator and/or a displayed indicator provided on a display of the head-mounted display 26) and select the desired head-mounted display 26 from a selection of one or more head-mounted displays 26.

The received guest information may be passed to a controller of the head-mounted display 26 and/or temporarily stored in memory of the head-mounted display 26. In embodiments, the stored guest information may be subsequently erased, cleared, replaced, or overwritten as provided herein. In an embodiment, the communication may be short-range or near-field wireless communication to prevent pairing with devices held by other guests 28 in the area. In an embodiment, one or both of the head-mounted display 26 or the guest mobile device 150 may activate an indicator of succession transmission of the guest information. For example, an LED light of the head-mounted display 26 may light up in a green color upon successful transmission. The guest information may be retained in temporary memory of the guest mobile device 150 or may be automatically deleted after transmission.

Because the guest information may be captured at a prior point in the distribution process, any delays in image capture may not cause bottlenecks for head-mounted display distribution. That is, the workflow may operate by requiring confirmation of image capture and guest information determination before the head-mounted display 26 is provided. Guests who complete this process smoothly can proceed forward in the process, while other guests who require assistance can be helped by operators. In some cases, guests 28 may elect to skip the capture and use default settings of the head-mounted display 26. Further, guest image capture may occur while the guest's hands are not holding the head-mounted displays 26, which may be dropped or mishandled if the guest 28 is attempting to capture an image while also holding the head-mounted display 26.

Once paired, the guest 28 may use the head-mounted display 26 during the attraction. The operations of the head-mounted display 26 can be tuned or adjusted using the guest information, such as interpupillary distance. In embodiments, the head-mounted display may additionally or alternatively use captured guest appearance information to customize displayed avatars. For example, if the guest 28 has a beard, a displayed AR/VR avatar can have a beard. If the guest 28 is a child, the displayed avatar can be smaller than other avatars. In certain embodiments, the guest information may be used by a controller of the head-mounted display 26 and is not communicated to a central attraction controller (see FIG. 9). Thus, any adjustments may be performed on the head-mounted display 26 or a local controller of the head-mounted display 26.

After the attraction cycle is complete, the guest 28 may return the head-mounted display 26 or may leave the head-mounted display 26 at the attraction location. The head-mounted display 26 may be available for use with the next guest 28, and so on. The previous guest information may be erased or written over.

FIG. 5 is an embodiment of the temporary device pairing system implemented with a kiosk 180. The kiosk 180 may operate to both capture the guest image and pair the head-mounted display 26. The kiosk 180 may be beneficial for guests 28 without guest mobile device 150 or whose mobile devices 150 are inoperative. The kiosk 180 may include a user interface 182. Interaction with the user interface 182 may activate a camera 184 of the kiosk 180 to capture the guest image. Determination of guest information may be performed on the guest kiosk 180, or a computer coupled to the guest kiosk 180, and pairing may occur by transmitting the guest information to the head-mounted display 26. For example, the guest information can be communicated wirelessly to communication circuitry of the head-mounted display 26. In an embodiment, the kiosk 180 may operate in a manner similar to a vending machine and prevent the guest 28 from accessing the head-mounted display 26 before the head-mounted display 26 is paired, for example before the guest information is communicated. For example, the head-mounted display 26 may be retained in a holder that is locked before the pairing is complete. Once the head-mounted display 26 is paired (e.g., has received the guest information), the holder may be unlocked. For example, a door permitting access to the head-mounted display 26 may be unlocked or released based on instructions from the kiosk 180. The kiosk 180 may automatically delete the captured guest images and/or guest information after a period of time. As in FIG. 4, the head-mounted display 26 can be used by the guest 28 and retained at the attraction after the attraction cycle for use by subsequent guests 28.

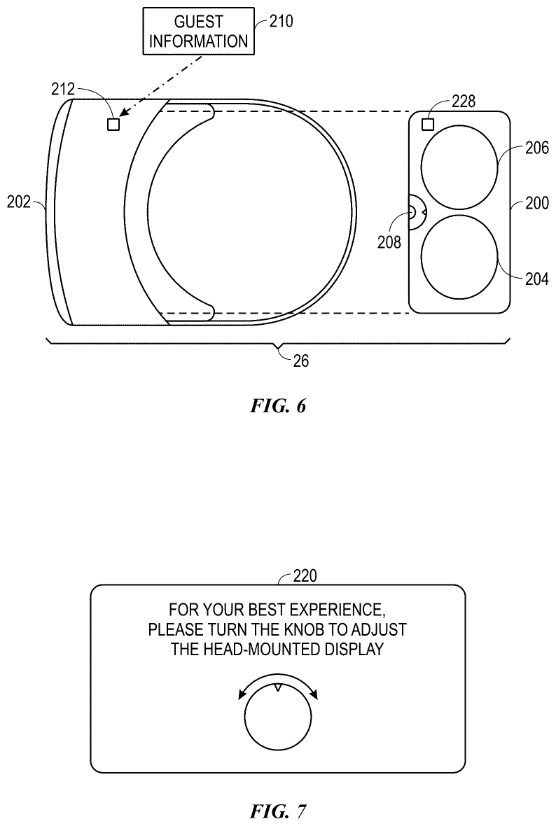

FIG. 6 is a schematic illustration of an embodiment of the head-mounted display 26 provided as a two-part system include a display device 200 and a guest interface device 202. The guest interface device 202 and the display device 200, when coupled, may form the head-mounted display 26. In an embodiment, the display device 200 includes one or more lenses that form a display of the display device. In an embodiment, the display device includes a left display 204 and a right display 206. A distance between the left display 204 and the right display 206 may be fixed or adjustable (e.g., via an adjustment knob 208.

The guest interface device 202 may be removably coupled to the display device 200 via a coupling interface. The coupling interface may include an electromagnetic coupling device, a press-fit assembly, a fastener, or any other suitable coupling device. When coupled together, the guest interface device 202 and the display device 200 are in an attached configuration so that the guest interface device 202 and the display device 200 are coupled together and function as an integrated unit. The guest interface device 202 may be a replaceable device that is provided at each attraction and that is returned at the exit for the attraction.

The guest interface devices 202 may be provided to guests during queuing or at ride dispatch to provide time for fit adjustment and guest-device pairing as disclosed herein, while the display device 200 are provided at a later time point, for example when guests are sitting on ride seats and do not have to walk or carry the relatively more fragile display device 200. The distribution of the guest interface devices 202 and display devices 200 may be at different locations and time points. The present techniques permit rapid association of a particular head-mounted display 26 with guest information based on guest information transmitted to the guest interface device 202 and, subsequently to the coupled display device 200. Any guest interface device 202 can couple to any display device 200. Thus, the guest 28 can take a paired guest interface device 202 to any seat of the ride vehicle 30 (see FIG. 2). Thus, so long as a guest 28 retains their display device 200, the guest may sit anywhere and/or receive any display device 200 and maintain pairing.

When the display device 200 couples to the guest interface device 202, the display device 200 receives the guest information 210 from communication circuitry 212 of the guest interface device 202. In an embodiment, the display device 200 has communication circuitry 228 that reads or receives the guest information 210 from a transmitter or tag, such as a radio frequency identification (RFID) tag, of the guest interface device 202. The tag may be an active or passive tag. The reading may be near field communication or contact-based, such that the reading is initiated only when the guest interface device 202 and the display device 200 are relatively close to one another to prevent reading of an uncoupled guest interface device 202 in the next seat. Once captured by the display device 200, the head-mounted display 26 may control one or more operations using the guest information 210. In an embodiment, the head-mounted display 26 controls the one or more operations using a controller on the head-mounted display and without communicating to any central controller. In an embodiment, the head-mounted display 26 communicates both the guest information 210 and its own head-mounted display unique information to a controller (e.g., an attraction controller, see FIG. 9) in a manner that links or associates the guest information with head-mounted display unique information. The controller then can provide instructions based on the guest information 210. Because the guest information 210 may be different for each guest 28, the head-mounted display 26 can operate in a customized manner and without necessarily knowing a guest name or personal identifying information. The pairing of the display device 200 with the guest interface device 202 is performed at or subsequent to the coupling of these components to one another and requires no additional inputs from the guests for an efficient and user-friendly process that avoids bottlenecks and improves ride efficiency.

FIG. 7 is an example user interface 220 that may be displayed on the head-mounted display 26 to guide the guest 28 through manual adjustment of the interpupillary distance using a manual adjustment device, such as the knob 208 (see FIG. 6). Responsive to receiving guest information of guest interpupillary distance and determining that the guest interpupillary distance deviates from a current display setting, the user interface 220 may provide a direction of knob movement to increase or decrease the distance between the display lenses (e.g., the left display 204 and a right display 206 of FIG. 6) such that the distance between the lenses corresponds to an associated interpupillary distance. Thus, the head-mounted display 26, or a coupled controller, may access a table or association of target display lens distances and corresponding guest interpupillary distances. The head-mounted display 26 may operate to determine the amount of mechanical adjustment and update the user interface 220 to provide additional guidance when the mechanical adjustment is sufficient or when additional adjustments should be made. Thus, in an embodiment, the head-mounted display 26 uses the guest information to control the display of instructions to adjust manual settings and sense when the manual settings are within target tolerance. As discussed, the guest information may additionally or alternatively be used to shift pixel display of left and right display lenses towards or away from one another in a software-based adjustment of an interpupillary distance setting without involving manual adjustment by the guest 28.

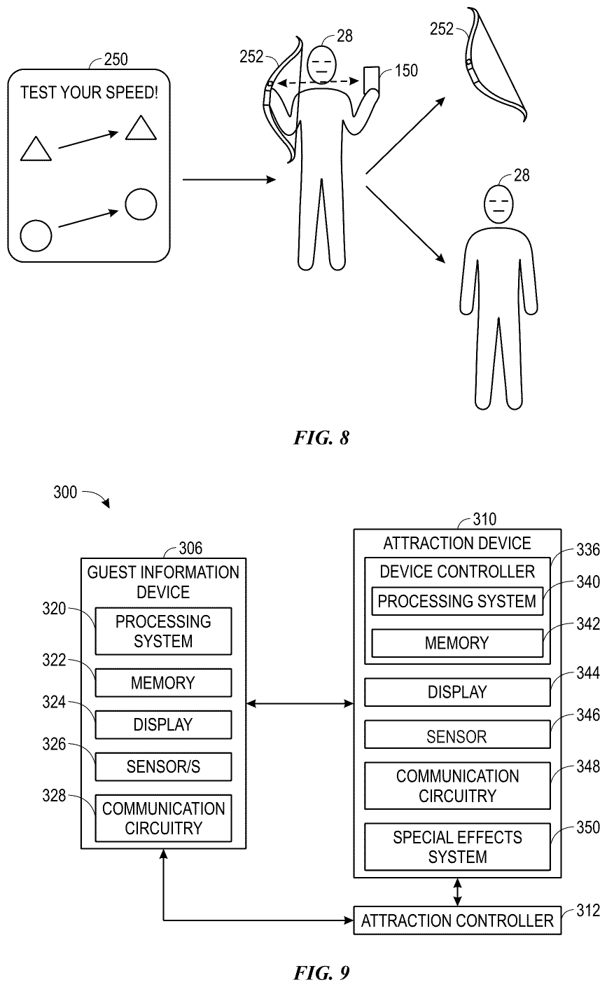

FIG. 8 is an example workflow of a temporary device pairing process that receives user input via a user interface 250 that is then used to pair an attraction device, illustrated as an attraction interactive object 252, to the guest 28. For example, the user interface 250 may be used to test reflex speed using a quick game. For guest 28 with faster reflexes, a response time of the attraction interactive object 252 may be adjusted. In one example, the reflexes may be scored based on game input, e.g., provided with a score of 1-10, with 10 being associated with fast reflexes. The score can be transmitted to the attraction interactive object 252 using the guest mobile device 150 or a kiosk or operator tablet to pair the attraction interactive object 252 with the guest. When the attraction interactive object 252 is used in the attraction, the reflex score stored in memory of the attraction interactive object 252 is communicated to a central controller to adjust game responsiveness. For example, displayed media targets may be faster. In another example, a trigger or drawstring tension may be adjusted up or down on the attraction interactive object 252 based on the reflex score.

FIG. 9 is a block diagram of a temporary device pairing system 300 as provided herein and with reference to certain features of FIGS. 1-8. The system may include a guest information device 306 and an attraction device 310. The guest information device 306 operates to capture or receive data indicative of and/or that is used to generate guest information and to transmit or pass the guest information to an attraction device 310 to temporarily pair the attraction device 310 to a guest 28, e.g., a single guest. Temporary pairing may include generating a temporary profile that can be cleared after the attraction cycle is complete or after a default period of time (e.g., a 24 hour period). In an embodiment, the guest information device 306 may be a guest mobile device 150, a kiosk 180, or other computing device that operates to capture data of the guest.

The guest information device 306 may include a processing system 320 that includes one or more processor(s) and memory 322 that includes one or more memory device(s). In some embodiments, the processing system 320 and memory 322 may be on the guest information device 306. In other embodiments, certain processing and/or memory functions may additionally or alternatively be remote or cloud-based. The processing system 320 may execute software programs and/or instructions to display images to a display 324. Moreover, the processing system 320 may include multiple microprocessors, one or more “general-purpose” microprocessors, one or more special-purpose microprocessors, and/or one or more application specific integrated circuits (ASICs), and/or one or more reduced instruction set (RISC) processors. The memory device may include one or more storage devices, and may store machine-readable and/or processor-executable instructions (e.g., firmware or software) for the processing system 320 to execute, such as instructions relating to determining guest information from captured data, such as a camera image. As such, the memory 322 may store, for example, control software, look up tables, configuration data, and so forth, to facilitate adjusting display of a virtual object. The memory 322 may include a tangible, non-transitory, machine-readable-medium, such as a volatile memory (e.g., a random access memory (RAM)) and/or a nonvolatile memory (e.g., a read-only memory (ROM), flash memory, hard drive, and/or any other suitable optical, magnetic, or solid-state storage medium). Additionally, the guest information device 306 may include one or more sensors 326 (e.g. camera, pressure sensors, capacitive sensors, hand-tracking sensors, eye-tracking sensors, inertial measurement units, microphones, and the like) that are used to acquire data of the guest that is processed on the guest information device 306, in an embodiment, and/or passed from the guest information device 306 to the attraction controller 312 to generate guest information.

The attraction device 310 may receive guest information from the guest information device 306 via communication circuitry 328 of the guest information device 306 that is received by corresponding communication circuitry 348 of the attraction device 310. The communication circuitry 328, 348 may facilitate wireless (e.g. ethernet, WAN, and the like) and/or wired (HDMI, USB, and so forth) communication between the guest information device 306 and the attraction device 310. In embodiments, the guest information device 306 and/or attraction device 310 may communicate with the attraction controller 312.

The attraction device 310 may be a head-mounted display or an attraction interactive object. The attraction device 310 may include a device controller 336 having a processing system 340 and memory 342, which may be configured as disclosed with respect to the processing system 320 and memory 322 of the guest information device 306. The controller 336 may execute software programs using the guest information and to control erasing or replacing the guest information on the attraction device 310. In an embodiment, the attraction device 310 may also execute software programs and/or instructions to adjust image displayed on a display 344, such as virtual features displayed on the head-mounted display. The attraction device 310 may include one or more sensors 346 as disclosed with respect to the guest information device 306 and a special effects system 350. In an embodiment, the special effects system 350 is responsive to the guest information. For example, the special effects system 350 may activate lighting and/or sound effects based on the determined guest information.

The present techniques permit personalization, tuning, and or customization of attraction devices without necessarily capturing guest identification information. In an embodiment, the attraction loading process is not slowed down by guests without guest profiles having to enter their information at the point of distribution or scanning or by guests having to provide their names or other information as part of the pairing process. Further, guests are able to freely seat themselves within an attraction, because the pairing information may be carried on guest interface devices 202 and/or guest mobile devices 150, which they take with them to their desired seats. Efficiency in the device distribution and dispatching process permits the attraction to operate on time and with greater throughput, thus increasing the overall guest experience and operating efficiency of the attraction. The present techniques permit efficient temporary association of a head-mounted display with a guest.

While only certain features of the disclosure have been illustrated and described herein, many modifications and changes will occur to those skilled in the art. It is, therefore, to be understood that the appended claims are intended to cover all such modifications and changes as fall within the true spirit of the disclosed embodiments.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A temporary device pairing system comprising:
a guest information device comprising:
a sensor configured to acquire guest data;
a processing system configured to determine guest information from the acquired data; and
communication circuitry configured to wirelessly communicate the guest information; and
a head-mounted display comprising:
head-mounted display communication circuitry configured to receive the guest information from the guest information device; and
a display configured to adjust display of images based on the received guest information.

2. The temporary device pairing system of claim 1, wherein the head-mounted display comprises a guest interface device configured to hold the display and that is removably coupled to the display, and wherein the head-mounted display communication circuitry comprises:
first communication circuitry of the guest interface device; and
second communication circuitry of the display, wherein the first communication circuitry receives the guest information and passes the guest information to the second communication circuitry when coupled to the display.

3. The temporary device pairing system of claim 2, wherein the guest interface device receives the guest information when removed from the display.

4. The temporary device pairing system of claim 1, wherein the guest information comprises an interpupillary distance, and wherein the display is configured to adjust the display of the images based on the interpupillary distance.

5. The temporary device pairing system of claim 1, comprising an attraction controller configured to transmit the images to the head-mounted display during an attraction cycle, and wherein the guest information is cleared from memory of the head-mounted display after the attraction cycle.

6. The temporary device pairing system of claim 1, wherein second guest information from a second guest is received at the head-mounted display after an attraction cycle, and wherein the second guest information replaces the guest information.

7. The temporary device pairing system of claim 1, wherein the guest information device is integrated into a kiosk that communicates the guest information to the head-mounted display.

8. The temporary device pairing system of claim 1, wherein the guest information device is a guest mobile device operating a software application.

9. The temporary device pairing system of claim 1, wherein the sensor comprises a camera.

10. The temporary device pairing system of claim 1, wherein the images are augmented reality and/or virtual reality images.

11. A temporary device pairing method comprising:
receiving, at a guest information device, a request to temporarily pair a head-mounted display with a guest;
activating a camera of the guest information device based on the request;
acquiring, using the camera, an image of the guest;
identifying one or more guest biometrics in the image; and
communicating guest information indicative of the one or more guest biometrics to the head-mounted display to cause the head-mounted display to adjust an operation of the head-mounted display based on the guest information.

12. The method of claim 11, comprising:
clearing the guest information from the memory of the head-mounted display.

13. The method of claim 12, wherein the clearing is based on receiving, at the head-mounted display, a signal indicative of an end of an attraction cycle of an amusement park attraction.

14. The method of claim 11, wherein identifying the one or more guest biometrics in the image comprises determining an interpupillary distance, and wherein the adjusted operation comprises causing display of a prompt to tune an interpupillary distance knob to align with the determined interpupillary distance.

15. The method of claim 11, wherein identifying the one or more guest biometrics in the image comprises determining an interpupillary distance, and wherein the adjusted operation comprises shifting display of images based on the determined interpupillary distance.

16. The method of claim 11, wherein identifying the one or more guest biometrics in the image comprises estimating guest height, and wherein the adjusted operation comprises scaling a displayed avatar of the guest based on the estimated guest height.

17. The method of claim 11, comprising releasing the head-mounted display from a holder of the guest information device after the communicating.

18. A temporary device pairing system comprising:
an attraction controller configured to control cycles of an amusement park attraction;
a guest information device comprising:
a sensor configured to acquire guest data;
a processing system configured to determine guest information from the acquired data; and
communication circuitry configured to wirelessly communicate the guest information; and
an attraction device in communication with the attraction controller comprising:
device communication circuitry configured to receive the guest information from the guest information device; and
a device controller configured operate based on instructions from the attraction controller and to adjust operation of the attraction device during an individual cycle of the amusement park attraction based on the guest information.

19. The temporary device pairing system of claim 18, wherein the device controller is configured to adjust an output of a special effects system based on the guest information.

20. The temporary device pairing system of claim 18, wherein the guest information comprises an estimated height or reflex speed.
